(19) United States
(12) Patent Application Publication
(10) Pub. No.: US 2008/0070668 A1
(43) Pub. Date: Mar. 20, 2008

(54) Gaming Apparatus, Systems and Methods

(76) Inventor: Mario R. Castellari, New South Wales (AU)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/576,609

(22) PCT Filed: Oct. 4, 2005
(86) PCT No.: PCT/AU05/01518

§ 371 Date: Oct. 8, 2007

(30) Foreign Application Priority Data
Oct. 4, 2004 (AU) 2004905715

(51) Int. Cl. A63F 13/00

(52) U.S. Cl. 463/16; 463/25; 463/31

(57) ABSTRACT

Gaming apparatus, e.g. an Electronic Gaming Machine (EGM) (1), includes a controller (2) for implementing games such as slots games. The controller (2) generates a plurality of win symbol generator mechanisms, such a set of virtual slot reels displayed on slot line (9), and allows for betting on sub-sets (11) of the slot reels, as well as on the full slot line (9). It therefore allows a number of games to be selected and bet on and played in unison.

The present application claims priority from Australian Provisional Patent Application No. 2004905715, the contents of which are incorporated herein in their entirety by reference.

### FIELD OF THE INVENTION

The present invention relates to gaming apparatus, systems and methods. It relates to electronic gaming machines and to networked gaming systems, such as Intranet and/or Internet based gaming systems.

### BACKGROUND OF THE INVENTION

Gaming machines have been a popular form of entertainment for many years. This popularity has been enhanced by the advent of electronic gaming machines, and by computer-based gaming systems, which may be provided over the Internet.

A player will typically place a bet, press a button or pull a lever to begin a game, and will win or lose based upon the gaming machine's play algorithm and random number generator.

Slot games are generally provided as either three or five reel games. Each reel is capable of displaying any one or more of a number of values, independent of the other reels. In gaming machines, the reels have historically been rotating cylinders with the values placed on the outer cylindrical surface of each cylinder and with a transparent window displaying a winning value for each reel, all of the winning displayed values together creating a slot line. By rotating the reels, different display values are seen by the player. Modern games do not necessarily make use of such cylinders, and may instead use value displays to generate and display virtual reels, each displaying one or more symbols on a screen, but each separate value display still being generally referred to as a reel.

An aim of the present invention is to provide gaming apparatus, systems and methods having novel features for enhancing gameplay.

### SUMMARY OF THE INVENTION

Embodiments of the invention provide apparatus, methods and systems for playing games. The games include provision of a plurality of mechanisms, which generate win symbols for use in the games. The games allow selection of at least one subset of the plurality of mechanisms, the at least one subset being played by a player. The player then wins based on the results from the subset(s) of the plurality of mechanisms. In one embodiment, a win for a selected subset is determined based on the win symbols generated by each mechanism in the subset. In an embodiment, each mechanism is a reel in a slots game.

In another embodiment, each mechanism generates a plurality of win symbols and a separate win is determined for each mechanism within a selected subset, based on the win symbols for that mechanism. An overall win may also be determined for the combination of mechanisms in the subset.

According to a first aspect of the invention, there is provided a gaming apparatus, including:
a plurality of win symbol generator mechanisms;
selecting means for allowing selection of at least one subset of the mechanisms;
activating means for activating at least the selected mechanisms to generate win symbols; and
determining means for determining a win based on a combination of selected win symbols generated by mechanisms within the subset.
The determining means may be for determining a win for a selected subset of mechanisms based on a combination of win symbols including at least one win symbol from each mechanism in the selected subset.

Each mechanism may generate a plurality of symbols at a time. Means may be provided to allow a player to select at least one win line including at least one win symbol from each mechanism in the selected subset(s). The plurality of win symbols may be used to determine wins in a number of conventional ways. The player may choose which of the plurality of symbols to bet on. For example, each mechanism may return two symbols, which may be provided in two win lines—upper and lower, or three symbols, which may provide three win lines, etc. The player may choose to bet only on e.g. the lower win line. Any other win lines will preferably still be displayed, but will not be used in determining the win.

The plurality of win symbol generator mechanisms may each be for generating a plurality of win symbols and the determining means may be for determining a win for each mechanism based on a combination of win symbols generated by that mechanism.

In preferred embodiments of the invention, the mechanisms are virtual mechanisms displayed on a screen, rather than physical mechanisms. However, physical mechanisms may also be provided. The win symbol may be generated by spinning of the mechanism, the symbol that the mechanism stops at being the win symbol.

The mechanisms may be configured to display the win symbols generated by the subset of mechanisms. The mechanisms may also be configured to generate win symbols, independent of whether or not they are within the selected subset(s), and display the generated win symbols.

The apparatus may be configured to determine wins for more than one selected subset, each subset including a different combination of mechanisms, and each subset to be activated in unison.

The gaming apparatus may further include game display means for displaying the win symbols for the selected subset(s) in addition to display by the mechanisms.

The selecting means may be configured to select at least one predetermined subset of mechanisms based on a choice of a player of the gaming apparatus. The selecting means may be configured to allow selection of at least one selected subset by selection of mechanisms by a player of the gaming apparatus. The selecting means may also be configured to include the plurality of mechanisms as a whole as a selected subset. The subsets may be predetermined and displayed to the player, who then decides on which of the predetermined subsets to bet. The subsets may include, for example, 3 or 5 adjacent mechanisms, and/or may include non-adjacent mechanisms.

The mechanisms may be configured to display win symbols of any of the plurality of mechanisms not within any of the selected subsets as shaded to indicate that they are not part of any selected subset(s).

The gaming apparatus may be an electronic gaming machine. The gaming apparatus may be a computer. In this case, the win symbols of the mechanisms may be displayed on a screen of the computer. The win symbols of the mechanisms may be generated by a remote central control in communication with the computer.

Each win symbol generator mechanism may itself include a further win symbol generator mechanism. Each mechanism may be a reel. The reels are preferably virtual reels, but may be physical reels.

In a second aspect of the invention, there is provided a method of operating a game, the method including:
providing a plurality of win symbol generator mechanisms,
allowing selection of at least one subset of the mechanisms;
activating at least the selected mechanisms to generate win symbols; and
determining a win based on a combination of win symbols generated by mechanisms within the subset.

The determination may include determining a win for a selected subset of mechanisms based on a combination of win symbols including at least one win symbol from each mechanism in the selected subset.

Some or all of the mechanisms may generate a plurality of win symbols at a time. A player may be able to select at least one win line including at least one win symbol from each mechanism in the selected subset(s). The plurality of win symbol generator mechanisms may each be for generating a plurality of win symbols and the determining may include determining a win for each mechanism based on a combination of win symbols generated by that mechanism.

The mechanisms may display the win symbols generated by the subset of mechanisms. The mechanisms may generate symbols, independent of whether or not they are within the selected subset(s), and display the generated win symbols.

Wins for more than one selected subset may be determined, each subset including a different combination of mechanisms, and each subset to be activated in unison.

At least one of the selected subset of mechanisms may be chosen from predetermined subsets of mechanisms by the player. At least one of the individual mechanisms in at least one subset may be selected by a player. The plurality of mechanisms as whole may be included as a selected subset in the game.

The mechanisms may display any of the plurality of mechanisms not within any of the selected subsets as shaded to indicate that they are not part of any selected subset.

According to a third aspect of the invention there is provided gaming software including code for controlling a processor to carry out the method of the second aspect of the invention.

According to a further aspect of the invention, there is provided a computer software product, including a carrier medium on which is carried gaming software according to the third aspect of the invention.

According to a further aspect of the invention, there is provided an electronic gaming machine, comprising:
a plurality of reels, each reel having a plurality of values and being
capable of displaying each of the possible values, at least one at a time, as a win symbol; and
a subset display, capable of displaying the win symbols, during a game, for at least one selected subset of the plurality of reels.

Preferably, the plurality of reels are each configured to update their win symbol on play of a game, independent of whether or not the reel is within the subset being played in the game. Preferably, a plurality of subset displays is provided, each subset representing a different combination of reels from the plurality of reels.

Instead of reels, discs may be provided as the mechanisms. Other devices both physical and virtual may be provided as the mechanisms. Where discs are provided, each disc may be split into a plurality of sectors, each sector providing a possible symbol to be output as a win symbol, which is generated by the spinning of the disc. One or more subsets of the discs may be chosen and a win may then be determined from the win symbols of the subset of discs.

Alternatively, a single shape, such as a polygon, e.g. a hexagon or an octagon, may be split into a plurality of sectors, each sector representing a mechanism, and being capable of generating multiple win symbols within each sector to be used in determining a win. A player may select some or all of the sectors to play.

Each of the mechanisms may, in turn, also include further mechanisms, which may be played as part of the game, or may be played as a feature or bonus game within the main game. The mechanisms and further mechanisms may be the same, or the further mechanisms may be different.

The system and method of the invention may be played on a single machine or apparatus, or may alternatively be played across a number of machines within a system. In the case of a number of machines playing the game, each may be provided with a different subset of mechanisms, the total plurality of mechanisms being common to all players within a system. The game may be provided as a bonus or jackpot game. Once again, the game may be provided over a plurality of linked gaming machines, and any one of the machines may activate the game given predetermined circumstances.

The gaming apparatus may take any suitable form, and could be e.g. an electronic gaming machine, or a computing or other electronic device. The game may be provided over the Internet or an intranet, or some other communications system, and may be provided on a client/server system.

According to a yet further aspect of the invention, there is provided a gaming apparatus including:
a plurality of win symbol generator mechanisms;
selecting means for allowing selection of at least one subset of the mechanisms;
activating means for activating at least the selected mechanisms to generate win symbols; and
determining means for determining a win for a selected subset of mechanisms based on a combination of win symbols generated by the subset of mechanisms.

According to a further aspect of the invention, there is provided a gaming apparatus including:
a plurality of win symbol generator mechanisms, each for generating a plurality of win symbols;
selecting means for allowing selection of at least one subset of the mechanisms;
activating means for activating at least the selected mechanisms to generate win symbols; and
determining means for determining a win for each mechanism based on a combination of win symbols generated by that mechanism.

### BRIEF DESCRIPTION OF THE DRAWINGS

Embodiments of the invention will now be described, purely by way of example, with reference to the accompanying drawings in which:

FIG. 1 shows a system according to an embodiment of the invention;

FIGS. 2a-2e show screen displays from the system of FIG. 1;

FIG. 3 shows a flow diagram of a method of operation of the system of FIG. 1;

FIG. 4 shows a system according to an embodiment of the invention;

FIG. 5 shows a display from the system of FIG. 4; and

FIG. 6 shows a flow diagram of a method of operation of the system of FIG. 4.

### DETAILED DESCRIPTION OF EMBODIMENTS OF THE INVENTION

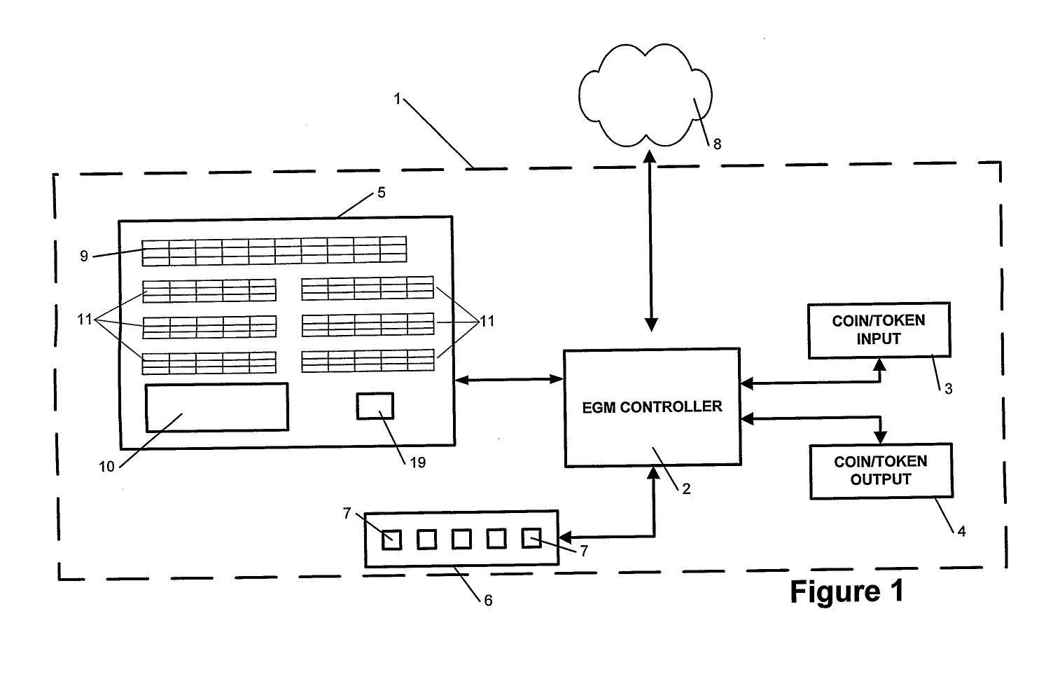

FIG. 1 shows a gaming apparatus according to an embodiment of the invention, which in this case takes the form of an electronic gaming machine (EGM) 1. The EGM 1 includes various standard components, such as a controller 2 for controlling the operation of the EGM 1 and the games run on it, a coin/token/card/bill validation input 3 for receiving bets, a coin/token/card output 4 for paying out winnings, a touch screen display 5 for displaying game screens receiving player choices, and a player input 6, including e.g. buttons 7, for allowing further player interaction. The buttons 7 could be provided on a further touch screen, or as part of the touch screen 5, or all inputs could be through buttons, without the use of a touch screen.

The EGM 1 may be a stand-alone machine. Alternatively, the EGM 1 may be networked with other EGMs and/or with a control centre via a suitable communications network 8, such as a LAN and/or WAN, in order to play networked (e.g. intranet or Internet) games, such as for example a linked jackpot, or to receive game instructions remotely.

Before play commences, the EGM 1 displays an initial gaming screen on the display 5. A player inserts coins and/or tokens into the EGM input 3, and initiates play of the game. A plurality of win symbol generating mechanisms is provided. In the present embodiment, the EGM 1 generates a plurality of virtual mechanisms, in the form of a slot line 9, on the touch screen 5. In the present embodiment, the win symbol generator mechanisms provide virtual slot reels that are ‘spun’ to output random win symbols. The win symbols are generated by the stopping of the reels at particular positions to provide particular symbols as the win symbols. The slot line 9 shows the win symbols for the plurality of virtual slot reels, in the present embodiment there are ten win symbols. A bet allocation area 10 is also provided on the screen 5.

Multiple subset displays 11 are also provided on the screen 5. The subset displays 11 each display the win symbols for five of the reels from the slot line 9. Each subset display 11 displays a different combination of the reels.

The player selects the amount to bet and selects the type of bet through the allocation area 10. The types of bet may include any of the standard slots bets. The player also chooses which of the subset displays 11 are to be played, as described in more detail below. The bets placed on each subset display 11 may be different. The player also selects the number of pay lines to be played in each subset.

Once a bet has been placed, the EGM 1 generates the win symbols for the slot line 9 in accordance with a stored gaming algorithm and random number generator. The EGM 1 generates the game, providing an animation of the slot line 9 with each reel spinning, so that the reels spin and the reels come to rest displaying the win symbols for each reel in the slot line 9.

The player can bet on a variable number of subsets of the slot line 9, shown in the subset displays 11. Thus, a player is able to bet on and to play multiple games at the same time. The player can bet on all of the subsets during a single round of betting using the same apparatus, and, because the slot line 9 is used for all of the subset displays 11, the games are played in unison.

The EGM 1 then pays out any winnings in accordance with the bets laid. In the present embodiment, the bets themselves are conventional.

The ability to bet on a number of games at once increases gameplay for the player. A much greater range of options is available, thus allowing the player greater control and flexibility. An increased range of pays and pay frequencies will be possible. Further, win events based across a number of the subsets are possible. It also benefits the EGM owner, as increased turnover from a single location is possible.

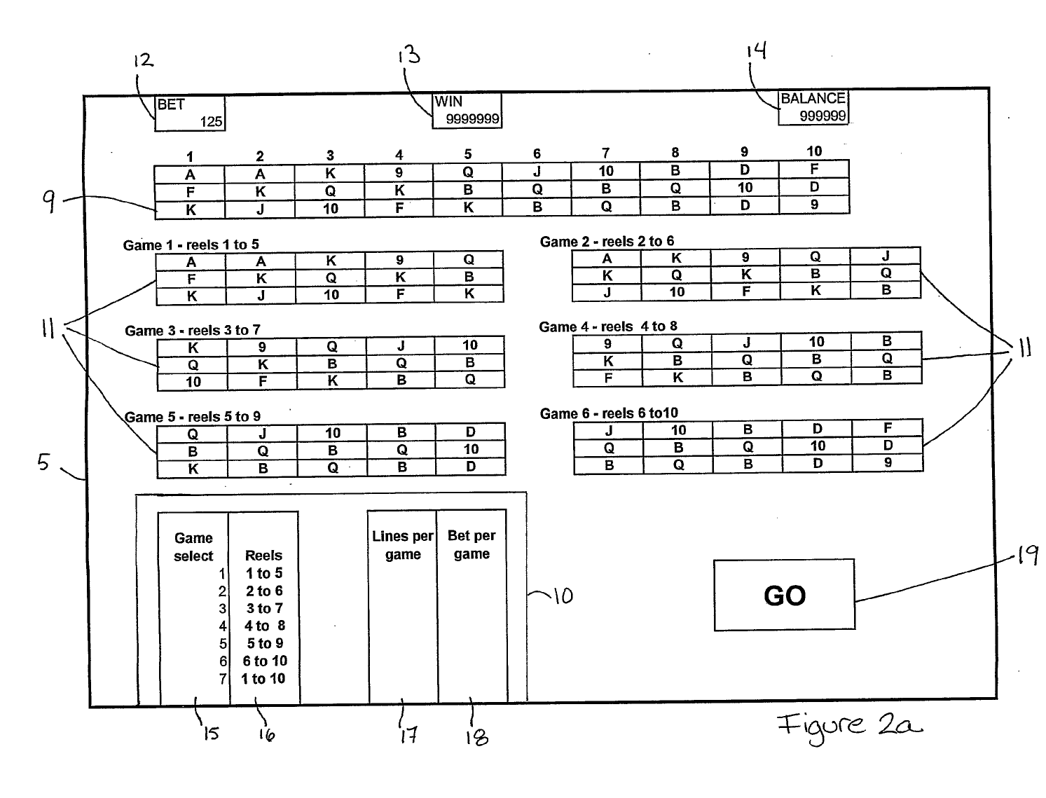

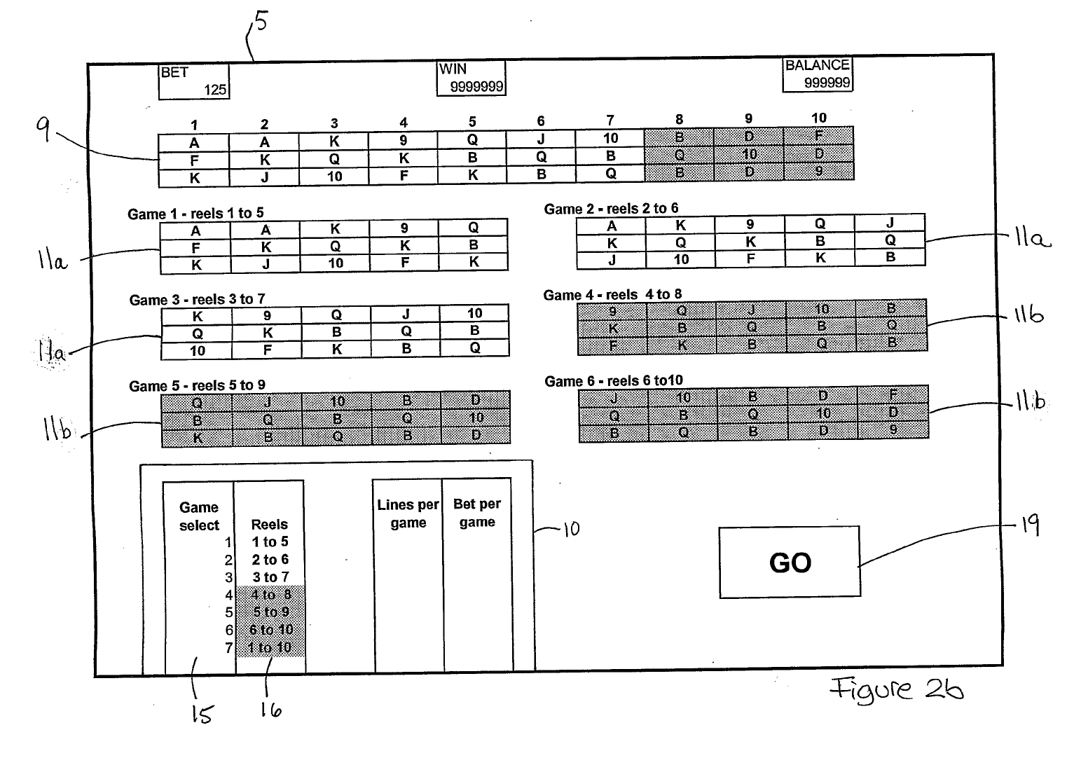

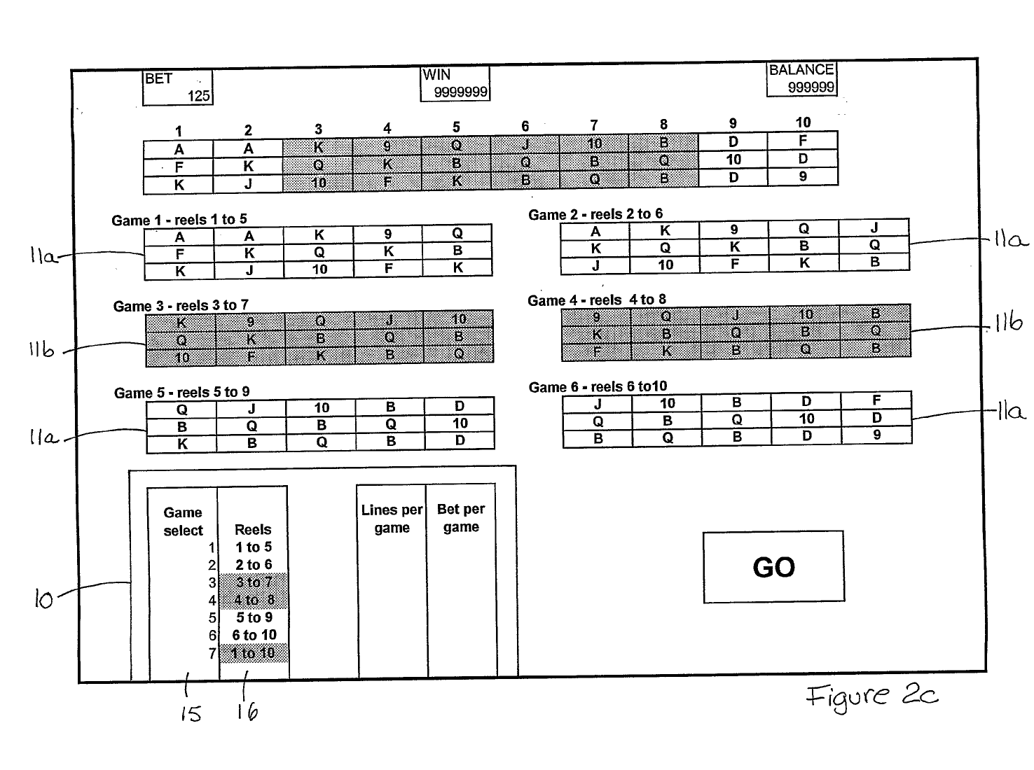

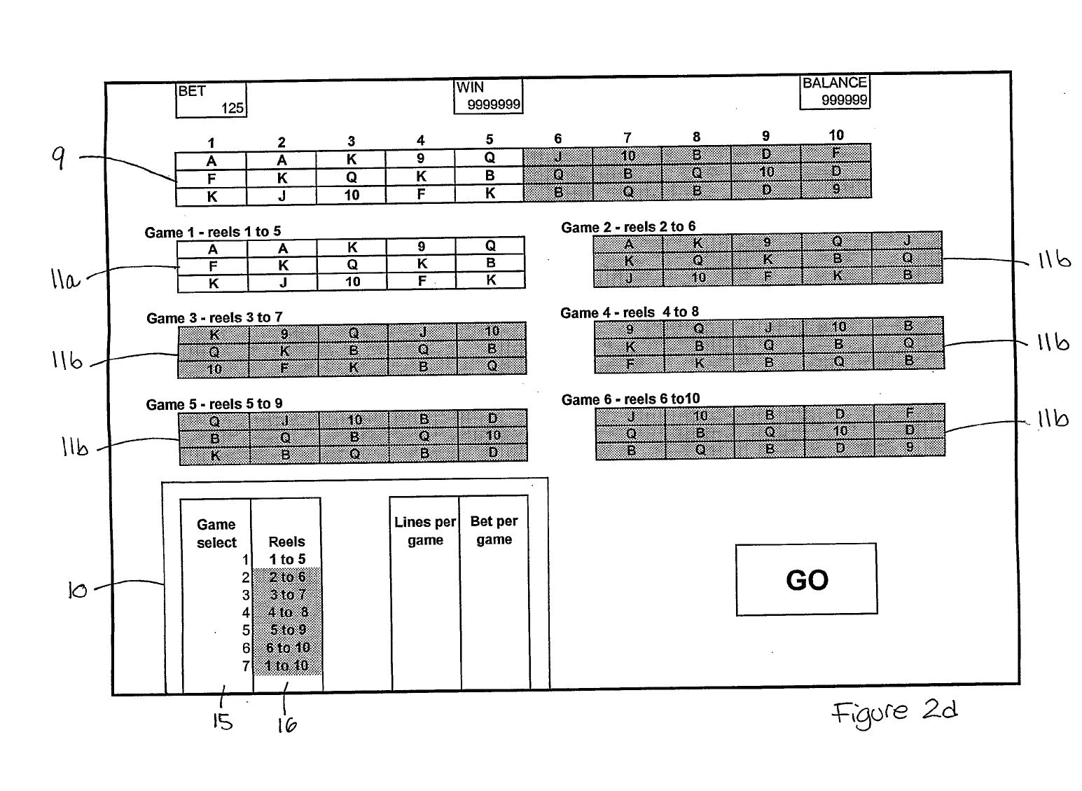

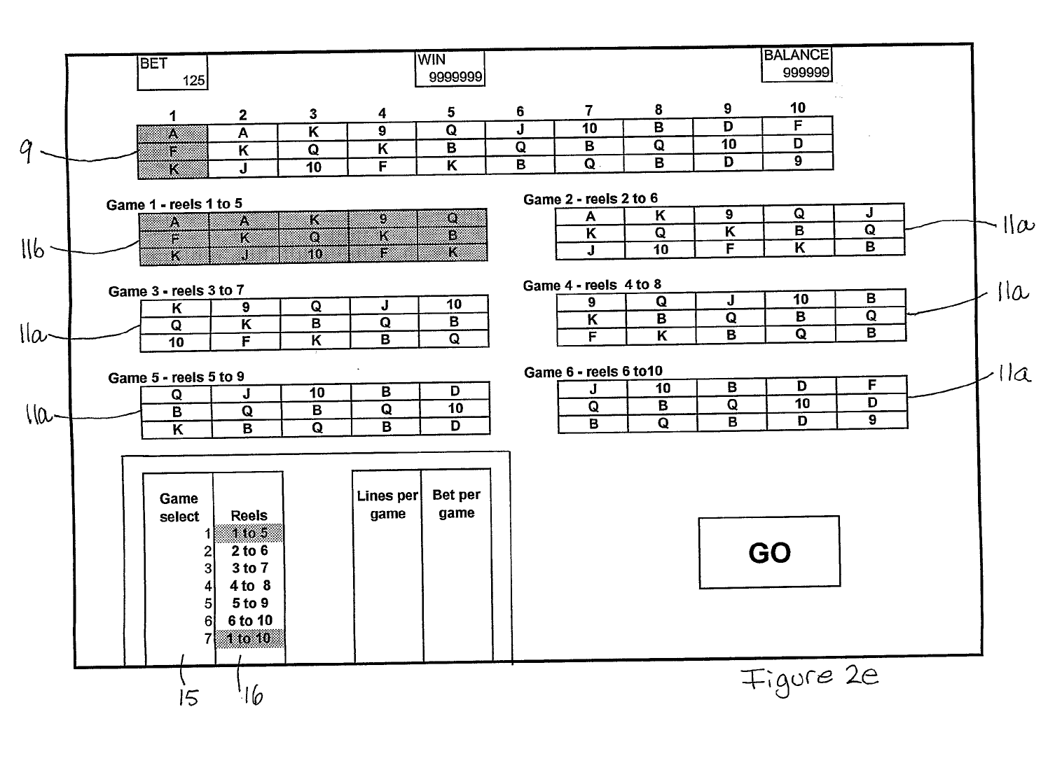

FIGS. 2a to 2e show displays from a gaming screen 5, as discussed in relation to the system of FIG. 1, in different states of play.

FIG. 2a shows the slot line 9, bet allocation area 10, subset displays 11, a game bet display 12, a total win display 13 and a balance display 14.

The slot line 9 has ten reels, arranged along a common virtual spin axis. The slot line 9 has three win symbols for each reel. Six subset displays 11 are provided. Each subset display 11 relates to a different combination of the reels in the slot line 9. Each subset display 11 shows five adjacent reels from the slot line 9, each starting with a different first reel.

Bet allocation area 10 allows selection from a number of different games. In the present embodiment, each game corresponds to a different subset being played with each refresh of the slot line values (each spin of the reels). Each subset display 11 plays a different game.

A player selects the game or games to be played from a game select menu touch screen area 15. In the present embodiment, seven games are playable, six of which are played on different single subsets, and the seventh of which is played on all of the reels. A subset not in play is shown shaded out in a play display area 16 to indicate that those subsets are not in the current game.

FIG. 2b shows the state of the display where games 1 to 3 have been chosen, corresponding to reels 1 to 7 being used in three subset displays 11a of the plurality of reels of the slot line 9.

The other subset displays 11b are shaded to show that they are not in play. Additionally, the reels in the slot line 9 that are not in play are also shaded, to indicate that they are not involved in play of the games on the subsets 11a. Additionally, the shaded subsets in play display area 16 show that games 4 to 7 are not in play in this game.

In FIG. 2c, games 1, 2, 5 and 6 are in play, after selection from the game select touch screen area 15. The shaded subsets in play display area 16 show that subsets corresponding to the reels 3-7, 4-8 and all ten reels (games 3, 4 and 7) are not being played. Reels 3 to 8 are lightly shaded to indicate that they are not in play for all of the potential subset displays (all of the available games).

FIG. 2d shows where only game 1 is in play, all other games being shaded out. Reels 5 to 10 of the slot line 9 are also shaded, to show that they are not in play.

FIG. 2e shows a screen where only games 1 and 7 have not been selected in the game select menu touch screen area 15. Only those games are shaded in the play display area 16, and only the subset display 11b for game 1 and the first reel from the slot line 9 are shaded.

Returning to FIG. 2a, the slot line 9 has three win symbols at any one time for each reel, making up three win lines. Some or all of these win lines can be played in a game for the chosen reels, and these win lines are chosen via a lines menu touch screen area 17. The bets per game are chosen from a bet menu touch screen area 18. The wins for the games are conventional, and may be left to right, right to left, anys, adjacent etc. There is no particularly required pay direction or maximum number of pay lines.

Once the reels, subsets, lines and bets are chosen, the ‘go’ button 19 is pressed. The win symbols for each reel in the slot line 9 are generated and displayed, and the subset displays 11 are populated with the win symbols for the corresponding reels. In the present embodiment, even though, as is the case in FIG. 2b, not all of the reels in the slot line 9 are being played in a game, they are still refreshed when the ‘go’ button 19 is pressed. The subset displays 11b that are not being played are also updated. In this way, a player can see if he/she would have won additional amounts if additional games were being played, encouraging further games to be played in future.

In the present embodiment, the reels shown in the subset displays are provided by the EGM 1. However, the combination of reels could be modified as desired, either from within the game or by player selection, with non-adjacent reels being playable in a game also. Additionally, in an alternative embodiment, the player may mix and match different reels, in order to customise his/her playing experience. For example, if a player believes that a particular reel provides a desired win symbol more often than others, he/she may choose that reel together with different combinations of the other reels, in order to attempt to increase their chances of winning. The player could, for example, drag particular reels into one of the subset displays using the touch screen, in order to make a customised subset display to be played as a game.

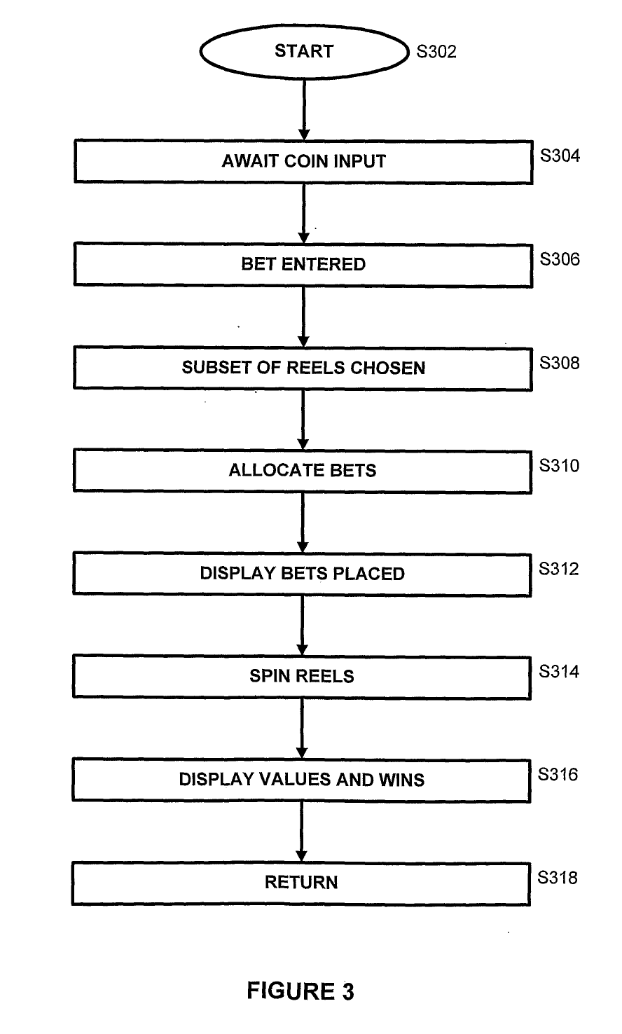

FIG. 3 shows a flowchart for the processing of a slots game capable of being carried out by the controller 2 shown in FIG. 1, including showing display screens, for example as shown in FIGS. 2a to 2e. In the present embodiment, the controller 2 runs software that incorporates a subroutine executing in the manner shown. The software is stored on the EGM controller 2.

At step S302, a start screen, e.g. as shown in FIG. 2a, is displayed. The input of coins, tokens, cards, bills or the like into the EGM 1 is awaited in step S304. Once a player has deposited sufficient value, the EGM 1 waits for the bet value to be entered at S306. The EGM 1 also waits for the player to choose the games to be played in that round by receiving inputs from the touch screen 5 and player input 6 at S308 (in particular, but not necessarily only, the games to be played and the number of lines that are active), and for the bets to be allocated to the particular games chosen at S310. In subsequent plays, the same game preferences (such as game selection and betting allocation) may be retained if the “go” button 19 is pressed without any choices being input into the EGM 1.

In an embodiment of the invention, the bets are allocated in a simple division, i.e. each selected game receives the same fraction of the total bet. Alternatively, the different games may be allocated different bet values, either by the player, or the EGM 1. The overall bet is shown in the game bet display 12 shown in FIG. 2a , and the individual bets shown in the bet menu touch screen area 18 at S312. The EGM 1 then waits for the “go” button 19 to be pressed by the player. Once the “go” button 19 is pressed, and in response to it, in step S314 the win symbols for each reel of the slot line 9 are generated, the reel spins are animated in accordance with the results and the EGM 1 determines any winnings for the player from each game, played on each subset display 11a at S316. The reel spins and win symbols are repeated in the corresponding subset displays 11a.

The routine finishes in step S318, and the start screen is redisplayed.

The routine may of course vary from the basic form shown, and may include various validity checks, bonus games and the like, and the step order may change.

In an alternative embodiment, the systems and methods of the embodiments described above are modified slightly. A plurality of win symbol generator mechanisms is still provided, and the apparatus shown in FIG. 1 may still be used. However, in this embodiment, the virtual reels are replaced with virtual discs. The win symbol generator mechanisms in this embodiment provide the virtual discs. Each disc is divided into a plurality of sectors, or wedges, on a first, or display, face. Each sector displays a symbol, and any of the sectors of each disc can be displayed as win symbols, one or more at a time. The discs are preferably virtual, i.e. they are generated and animated, rather than being real discs. However, real discs can also be employed.

The same method of operation may be used as discussed in relation to FIG. 3, with the exception that virtual discs are generated, rather than virtual reels. The screen shots may also be the same, with the exception that, in a corresponding embodiment, three wedges from each disc will be shown as win symbols, rather than three win symbols from each reel. A slot line is conveniently formed of the win symbols of each of the discs. Additionally, win symbols for each wedge can be reproduced in the subset displays, as described in relation to the previous embodiment, above.

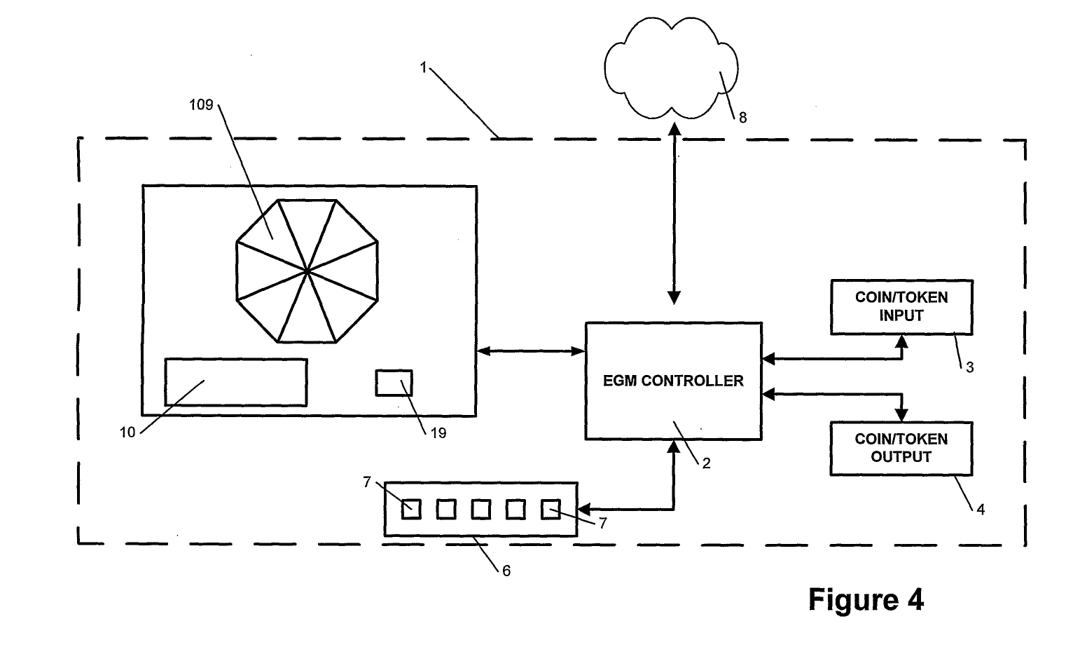

A system of a further embodiment is shown in FIG. 4. The system of FIG. 4 corresponds to that described with regard to the system shown in FIG. 1, except that the display shows a single octagonal shape rather than the slot line 9. Like numbered elements have corresponding functions. Additionally, separate subset displays are not shown in the present embodiment (although, in alternative embodiments, they may be shown).

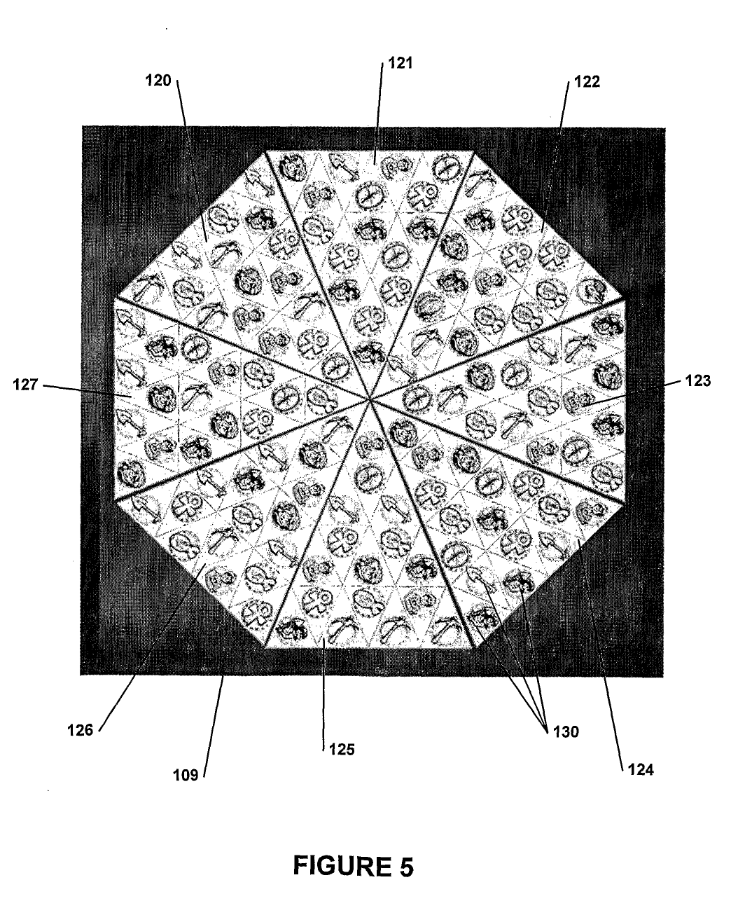

The display shape is shown in more detail in FIG. 5. FIG. 5 shows only the game display area 109 of a screen, which replaces the slot line 9 described above. The display area 109 is split into a plurality of sectors 120-127 (in this embodiment, eight), and each sector 120-127 shows a win symbol generator mechanism. Different subsets of the sectors 120-127 of the display area 109 can be selected, and the subsets of sectors played, as described below.

Each sector includes a plurality of win symbols 130, which are generated by the mechanisms. In the present embodiment, win symbols 130 are generated within each sector on activation of the mechanisms. The wins are then determined.

FIG. 6 shows a flow diagram of a possible operation of a system according to FIG. 4, including showing display screens, for example as shown in FIG. 5. At S602, a start screen, e.g. as shown in FIG. 5, is displayed. The input of coins, tokens, cards, bills or the like into the EGM 1 is awaited in step S604. Once a player has deposited sufficient value, the EGM 1 waits for the bet value to be entered at S606. The EGM 1 also waits for the player to choose the sectors to be played in that round by receiving inputs from the touch screen 5 and player input 6 at S608 (in particular, but not necessarily only, the games to be played and the number of sectors that are active). Any of the sectors may be chosen. For example, sectors 120, 122, 125 and 127 may be selected to be played. The bets to be allocated to the particular games are chosen at S610. In subsequent plays, the same game preferences (such as game selection and betting allocation) may be retained if the go button 19 is pressed without any choices being input into the EGM 1. In the present embodiment, the win symbol generator mechanisms provide multiple win symbols 130 within each sector.

In an embodiment of the invention, the bets are allocated in a simple division, i.e. each selected sector receives the same fraction of the total bet. Alternatively, the different games may be allocated different bet values, either by the player, or the EGM 1. The overall bet and the individual bets are shown in the allocation area 10 at S612. The bets may be as described in relation to previous embodiments, where appropriate. The EGM 1 then waits for the “go” button 19 to be pressed by the player. Once the “go” button 19 is pressed, and in response to it, in step S614 the win symbols 130 for each sector 120-127 of the shape 109 are generated. The win symbols replace those previously displayed and are generated by the EGM 2 using a stored gaming algorithm and random number generator. Some symbols may be generated more often than others, depending on the algorithm. The win symbols 130 are generated regardless of whether or not the sector in which they are displayed has been selected at S608. At S616, the win symbols 130 are displayed in accordance with the results and the EGM 1 determines any winnings for the player from each sector 120-127. A win may occur when more than a predetermined number of identical symbols are generated within a sector. Alternatively, the win may be a number of identical adjacent symbols, or may be any other conventional win criterion.

The routine finishes in step S618, and the start screen is redisplayed. Additional wins may be provided by determining combinations of win symbols 130 from more than one mechanism. Once again, the routine may vary from the basic form shown, and may include various validity checks, bonus games and the like, and the step order may change.

In a possible addition, a plurality of win symbol generator mechanisms may be provided within each sector, and a subset of the mechanisms within each sector can be chosen, once the subset(s) of sectors has been chosen. Each win symbol generator mechanism then generates a win symbol when activated, and the system determines a win based on the generated win symbols.

In another alternative, the display may show a different shape that is divided into sectors, e.g. a hexagon or other polygon.

In a further alternative embodiment, a feature game is provided within the game of any one of the above embodiments. In the feature game, a winning combination of symbols of the win symbol generator mechanisms causes the feature game to be played. In the feature game, the winning mechanisms only are played. Each winning mechanism itself includes one or more further win symbol generator mechanisms, which are then played, for example by simple spins, in order to win a bonus. In this way, a mechanism within mechanism type game is provided.

Although, in embodiments described above, the symbol selector mechanisms are described providing one or more virtual discs, reels, or the like, it will be appreciated that physical mechanisms could also be provided within the invention. Additionally, although discs and reels have been described herein by way of example, other mechanisms could also be employed within the invention.

Instead of the gaming apparatus being an EGM, it may take any other suitable form, and could for example comprise a game provided on a computing or other electronic device, such as on a personal computer, PDA, mobile phone, digital television or the like. The game may also be provided over an intranet, the Internet, or some other communications system, such as a mobile telephone system. The game may be provided on a client/server system. In the case of a multiplayer game, each subset of mechanisms may be played on a different console, computer or other device, with a display of all mechanisms also provided to all players. The display of all mechanisms may be provided by a separate display, for example as a large screen shown above a plurality of play consoles.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

1. A gaming apparatus including:
a plurality of win symbol generator mechanisms;
selecting means for allowing selection of at least one subset of the mechanisms;
activating means for activating at least the selected mechanisms to generate win symbols; and
determining means for determining a win based on a combination of win symbols generated by mechanisms within the subset.

2. A gaming apparatus according to claim 1, wherein the determining means is for determining a win for a selected subset of mechanisms based on a combination of win symbols including at least one win symbol from each mechanism in the selected subset.

3. A gaming apparatus according to claim 1, wherein each win symbol generator mechanism is a reel, and the win symbols are display values of the reels.

4. A gaming apparatus according to claim 1, wherein each mechanism is configured to generate a plurality of win symbols at a time.

5. A gaming apparatus according to claim 4, including means for allowing a player to select at least one win line including at least one win symbol from each mechanism in the selected subset(s).

6. A gaming apparatus according to claim 1, wherein the plurality of win symbol generator mechanisms are each for generating a plurality of win symbols, and the determining means is for determining a win for each mechanism based on a combination of win symbols generated by that mechanism.

7. A gaming apparatus according to claim 1, wherein the mechanisms are configured to display the win symbols generated by the subset of mechanisms.

8. A gaming apparatus according to claim 1, wherein the mechanisms are configured to generate win symbols, independent of whether or not they are within the selected subset(s), and display the generated win symbols.

9. A gaming apparatus according to claim 1, wherein the apparatus is configured to determine wins for more than one selected subset, each subset including a different combination of mechanisms, and each subset to be activated in unison.

10. A gaming apparatus according to claim 1, further including game display means for displaying the win symbols for the selected subset(s) in addition to display by the mechanisms.

11. A gaming apparatus according to one claim 1, wherein the selecting means is configured to select at least one predetermined subset of mechanisms based on a choice of a player of the gaming apparatus.

12. A gaming apparatus according to claim 1, wherein the selecting means is configured to allow selection of at least one subset by selection of mechanisms by a player of the gaming apparatus.

13. A gaming apparatus according to claim 10, wherein the selecting means is configured to include the plurality of mechanisms as a whole as a selected subset.

14. A gaming apparatus according to claim 1, wherein the mechanisms are configured to display win symbols for any of the plurality of mechanisms not within any of the selected subsets as shaded to indicate that they are not part of any selected subset.

15. A gaming apparatus according to claim 1, wherein the gaming apparatus is an electronic gaming machine.

16. A gaming apparatus according to claim 1, wherein the gaming apparatus is a computer.

17. A gaming apparatus according to claim 16, wherein the win symbols of the mechanisms are displayed on a screen of the computer.

18. A gaming apparatus according to claim 16, wherein the win symbols of the mechanisms are generated by a remote central control in communication with the computer.

19. A gaming apparatus according to claim 1, wherein each win symbol generator mechanism itself includes a further win symbol generator mechanism.

20. A method of operating a game, the method including:
providing a plurality of win symbol generator mechanisms,
allowing selection of at least one subset of the mechanisms;
activating at least the selected mechanisms to generate win symbols; and
determining a win based on a combination of win symbols generated by mechanisms within the subset.

21. A method according to claim 20, wherein the determining includes determining a win for a selected subset of mechanisms based on a combination of win symbols including at least one win symbol from each mechanism in the selected subset.

22. A method according to claim 20, wherein each mechanism generates a plurality of win symbols at a time.

23. A method according to claim 22, including allowing a player to select at least one win line including at least one win symbol from each mechanism in the selected subset(s).

24. A method according to claim 20, wherein the plurality of win symbol generator mechanisms are each for generating a plurality of win symbols, and the determining includes determining a win for each mechanism based on a combination of win symbols generated by that mechanism.

25. A method according to claim 20, wherein the mechanisms display the win symbols generated by the subset of mechanisms.

26. A method according to claim 20, wherein the mechanisms generate win symbols, independent of whether or not they are within the selected subset(s), and display the generated win symbols.

27. A method according to claim 20, wherein the apparatus determines wins for more than one selected subset, each subset including a different combination of mechanisms, and each subset to be activated in unison.

28. A method according to claim 20, wherein at least one of the selected subset of mechanisms is chosen from a set of predetermined subsets of mechanisms by a player.

29. A method according to claim 20, wherein at least one of the individual mechanisms in at least one subset of mechanisms is selected by a player.

30. A method according to claim 20, wherein the plurality of mechanisms as a whole is included as a selected subset in the game.

31. A method according to claim 20, wherein the mechanisms display any of the plurality of mechanisms not within any of the selected subsets as shaded to indicate that they are not part of any selected subset.

32. Gaming software including code for controlling a processor to carry out the method of claim 20.

33. A computer software product, including a carrier medium on which is carried gaming software according to claim 32.

34. A gaming apparatus including:
a plurality of win symbol generator mechanisms;
selecting means for allowing selection of at least one subset of the mechanisms;
activating means for activating at least the selected mechanisms to generate win symbols; and
determining means for determining a win for a selected subset of mechanisms based on a combination of win symbols generated by the subset of mechanisms.

35. A gaming apparatus including:
a plurality of win symbol generator mechanisms, each for generating a plurality of win symbols;
selecting means for allowing selection of at least one subset of the mechanisms;
activating means for activating at least the selected mechanisms to generate win symbols; and
determining means for determining a win for each mechanism based on a combination of win symbols generated by that mechanism.

36. An electronic gaming machine, comprising:
a plurality of reels, each reel having a plurality of values and being capable of displaying each of the possible values, at least one at a time, as a win symbol; and
a subset display, capable of displaying win symbols, during a game, for at least one selected subset of the plurality of reels.

37. An electronic gaming machine according to claim 36, wherein the plurality of reels are each configured to update their win symbol on play of the game, independent of whether or not the reel is within the subset being played in the game.

38. An electronic gaming machine according to claim 37, wherein a plurality of subset displays are provided, each subset representing a different combination of reels from the plurality of reels.
